(19) United States
(12) Patent Application Publication
(10) Pub. No.: US 2025/0124654 A1
(43) Pub. Date: Apr. 17, 2025

(54) TECHNIQUES FOR GENERATING THREE-DIMENSIONAL REPRESENTATIONS OF ARTICULATED OBJECTS

(71) Applicant: NVIDIA CORPORATION, Santa Clara, CA (US)

(72) Inventors: Bowen WEN, Bellevue, WA (US); Stanley BIRCHFIELD, Sammamish, WA (US); Jonathan TREMBLAY, Redmond, WA (US); Valts BLUKIS, Seattle, WA (US); Dieter FOX, Seattle, WA (US); Yijia WENG, Palo Alto, CA (US)

(21) Appl. No.: 18/740,264

(22) Filed: Jun. 11, 2024

Related U.S. Application Data
(60) Provisional application No. 63/586,042, filed on Sep. 28, 2023.

(51) Int. Cl. G06T 17/20; B25J 9/16; G06T 7/11; G06T 7/20; G06T 19/00

(52) U.S. Cl. CPC G06T 17/20; B25J 9/1605; G06T 7/11; G06T 7/20; G06T 19/006; G06T 2207/10024

(57) ABSTRACT

One embodiment of a method for generating an articulation model includes receiving a first set of images of an object in a first articulation and a second set of images of the object in a second articulation, performing one or more operations to generate first three-dimensional (3D) geometry based on the first set of images, performing one or more operations to generate second 3D geometry based on the second set of images, and performing one or more operations to generate an articulation model of the object based on the first 3D geometry and the second 3D geometry.

### CROSS-REFERENCE TO RELATED APPLICATIONS

This application claims priority benefit of the U.S. Provisional Patent Application titled, “DIGITAL TWINING FOR ARTICULATED OBJECTS,” filed on Sep. 28, 2023 and having Ser. No. 63/586,042. The subject matter of this related application is hereby incorporated herein by reference.

### BACKGROUND

### Technical Field

Embodiments of the present disclosure relate generally to computer science, artificial intelligence (AI), and machine learning and, more specifically, to techniques for generating three-dimensional representations of articulated objects.

### Description of the Related Art

Articulated objects are objects composed of multiple rigid parts connected by joints that allow rotational or translational motion of the parts in one, two, or three degrees of freedom. For example, a microwave is an articulated object whose door can rotate to open by different degrees, which are also referred to as different articulations.

Three-dimensional (3D) representations of articulated objects have many applications, such as controlling a robot to interact with the articulated objects based on the 3D representations or placing the 3D representations within virtual environments. One conventional approach for generating 3D representations of articulated objects is to train a machine learning model to generate a 3D representation of a particular type of object from captured images of a given object of that particular type.

One drawback of the above approach is that the trained machine learning model can only generate 3D representations of objects of the particular type for which the machine learning model was trained. That is, the trained machine learning model is not generalizable to other types of objects. Another drawback of the above approach is that, as a general matter, conventional machine learning models can only be trained to generate 3D representations of objects having a single articulation. For example, a conventional machine learning model could be trained to generate a 3D representation of a microwave having a single door that can open, but not a refrigerator having two doors that can open separately.

As the foregoing illustrates, what is needed in the art are more effective techniques for reconstructing 3D articulated objects.

### SUMMARY

One embodiment of the present disclosure sets forth a computer-implemented method for generating an articulation model. The method includes receiving a first set of images of an object in a first articulation and a second set of images of the object in a second articulation. The method also includes performing one or more operations to generate first three-dimensional (3D) geometry based on the first set of images. The method further includes performing one or more operations to generate second 3D geometry based on the second set of images. In addition, the method includes performing one or more operations to generate an articulation model of the object based on the first 3D geometry and the second 3D geometry.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that 3D reconstructions of articulated objects generated using the disclosed techniques can be more accurate and stable than 3D reconstructions of articulated objects generated using conventional approaches. In addition, the disclosed techniques can handle articulated objects having more than one movable part as well as arbitrary novel objects, because the disclosed techniques do not rely on an object shape or structure prior. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments;

FIG. 2 is a more detailed illustration of the three-dimensional (3D) representation application of FIG. 1, according to various embodiments;

FIG. 3 is a more detailed illustration of the object model generator of FIG. 2, according to various embodiments;

FIG. 4 is a more detailed illustration of the articulation model generator of FIG. 2, according to various embodiments;

FIGS. 5A-5C illustrate exemplar inputs and outputs of the 3D representation application of FIG. 1, according to various embodiments; and

FIG. 6 is a flow diagram of method steps for generating a three-dimensional representation of an articulated object, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating digital three-dimensional (3D) representations of articulated objects. In some embodiments, a 3D representation application receives as input images of an articulated object from multiple viewpoints and in two different articulations. The 3D representation application generates an object model for each articulation via a first optimization technique using the input images associated with the articulation. Then, the 3D representation application generates 3D geometry from each object model using a reconstruction technique. Thereafter, the 3D representation application generates an articulation model via a second optimization technique using the 3D geometry generated from each object model. The articulation model includes a segmentation model that segments parts of the articulated object and a set of motion parameters defining motions of each of the segmented parts. In some embodiments, the second optimization technique includes performing backpropagation to update the motion parameters along with parameters of the segmentation model and minimizing a loss function that includes a consistency loss term that penalizes geometric and appearance inconsistencies between corresponding points in different articulations, a matching loss term that penalizes unmatching image features between pixel pairs in different articulations, and a collision loss term that penalizes collisions between parts after applying a predicted forward motion.

The techniques disclosed herein for generating 3D representations of articulated objects have many real-world applications. For example, those techniques could be used to generate digital representations of real-world articulated objects that can be imported into an extended reality (XR) environment, such as a virtual reality (VR) environment, an augmented reality (AR) environment, or a mixed reality (MR) environment. The generated 3D representations can also help robots to interact with articulated objects using visual observations.

The above examples are not in any way intended to be limiting. As persons skilled in the art will appreciate, as a general matter, the techniques for generating and utilizing 3D representations of articulated objects can be implemented in any suitable application.

### System Overview

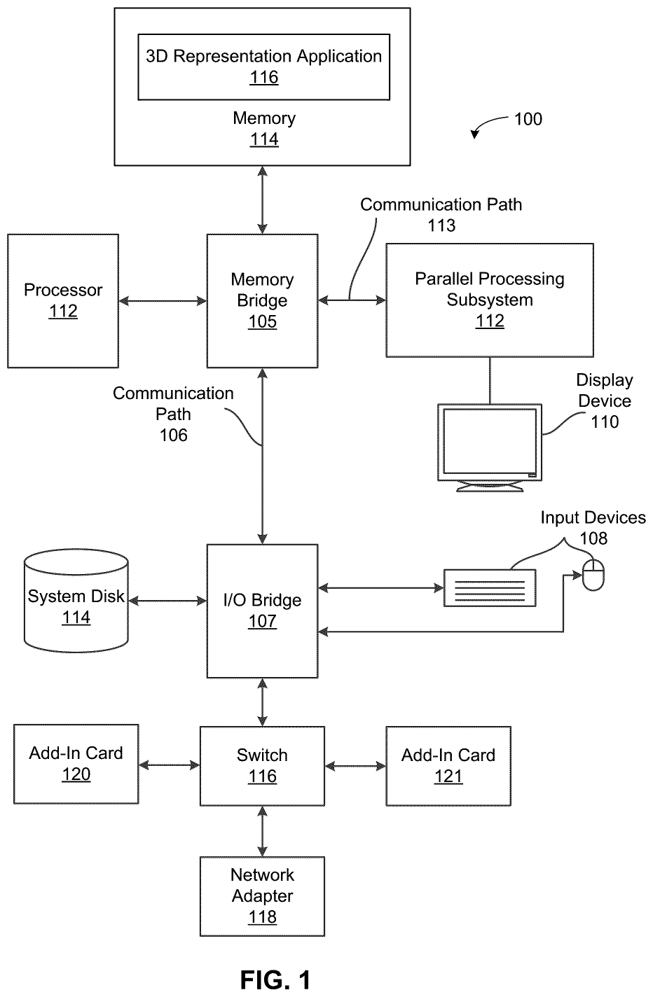

FIG. 1 illustrates a computing device 100 configured to implement one or more aspects of various embodiments. As persons skilled in the art will appreciate, computing device 100 can be any type of technically feasible computer system, including, without limitation, a server machine, a server platform, a desktop machine, laptop machine, a hand-held/mobile device, or a wearable device. In some embodiments, computing device 100 is a server machine operating in a data center or a cloud computing environment that provides scalable computing resources as a service over a network. In some embodiments, computing device 140 can include similar components as computing device 100.

In various embodiments, computing device 100 includes, without limitation, a processor 112 and a memory 114 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In some embodiments, I/O bridge 107 is configured to receive user input information from optional input devices 108, such as a keyboard or a mouse, and forward the input information to processor 112 for processing via communication path 106 and memory bridge 105. In some embodiments, computing device 100 may be a server machine in a cloud computing environment. In such embodiments, computing device 100 may not have input devices 108. Instead, computing device 100 may receive equivalent input information by receiving commands in the form of messages transmitted over a network and received via network adapter 118. In some embodiments, switch 116 is configured to provide connections between I/O bridge 107 and other components of computing device 100, such as a network adapter 118 and various add-in cards 120 and 121.

In some embodiments, I/O bridge 107 is coupled to a system disk 114 that may be configured to store content and applications and data for use by processor 112 and parallel processing subsystem 112. In some embodiments, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing device 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. Such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 114 includes at least one device driver configured to manage the processing operations of the one or more PPUs within parallel processing subsystem 112.

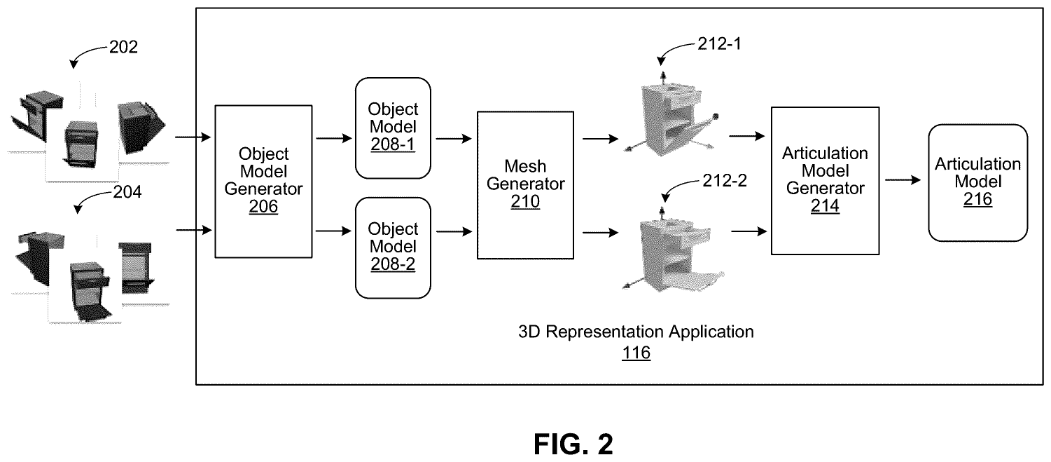

In addition, system memory 114 includes 3D representation application 116 that generates 3D representations of articulated objects and articulation models for each articulation part. In some embodiments, 3D representation application 116 receives input RGB-D (red, green, blue, depth) images of an articulated object from multiple viewpoints and in two different articulation states. 3D representation application 116 first reconstructs 3D object geometry (also referred to herein as 3D object geometry shapes) for each articulation state, and 3D representation application 116 then generates an articulation model that associates two articulation states by exploiting correspondences between such states. Operations performed by 3D representation application 116 are described in greater detail below in conjunction with FIGS. 2-6. Although described herein primarily with respect to 3D representation application 116, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with processor 112 and other connection circuitry on a single chip to form a system on chip (SoC).

In some embodiments, processor 112 is the master processor of computing device 100, controlling and coordinating operations of other system components. In some embodiments, processor 112 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 114 could be connected to processor 112 directly rather than through memory bridge 105, and other devices would communicate with system memory 114 via memory bridge 105 and processor 112. In other embodiments, parallel processing subsystem 112 may be connected to I/O bridge 107 or directly to processor 112, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

### Generating Three-Dimensional Representations of Articulated Objects

FIG. 2 is a more detailed illustration of the 3D representation application 116 of FIG. 1, according to various embodiments. As shown, 3D representation application 116 includes an object model generator 206, a mesh generator 210, and an articulation model generator 214. In operation, 3D representation application 116 receives sets of RGB-D images corresponding to two different articulation states 202 and 204 of an unknown articulated object, shown as a desk. Each of the sets of RGB-D images 202 and 204 include images that are captured from multiple different viewpoints. In some embodiments, 3D representation application 116 receives sets of RGB-D images corresponding to an initial articulation state and a final articulation state of an articulated object. 3D representation application 116 processes the received images in two main steps: first, 3D representation application 116 generates 3D object shapes 212-1 and 212-2, and then 3D representation application 116 generates an articulation model 216.

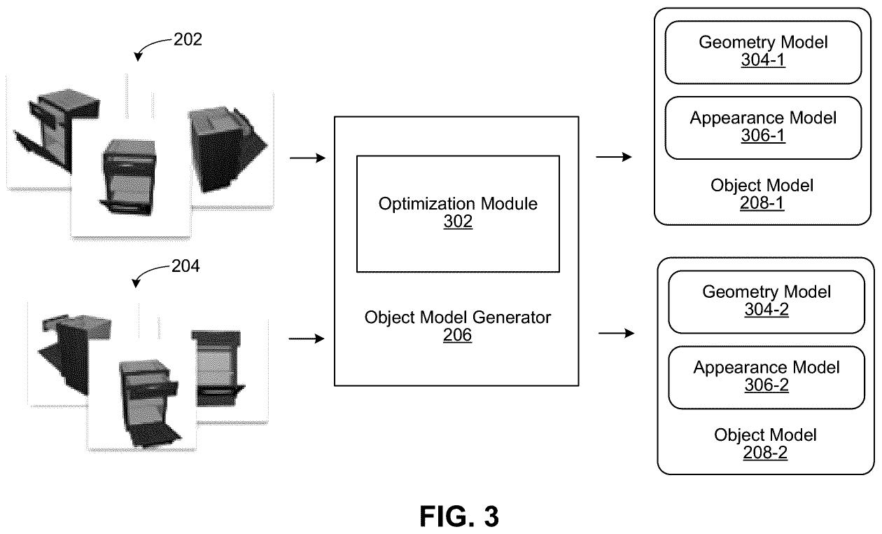

3D object shapes 212-1 and 212-2 are 3D reconstructions of each set of RGB-D images 202 and 204, respectively, corresponding to an articulation state. To generate 3D object shapes 212-1 and 212-2, object model generator 206 generates object models 208-1 and 208-2 which represent the geometry and appearance of a 3D reconstructed articulated object representing an object (the desk in the illustrated example) within the corresponding sets of input images 202 and 204. In some embodiments, object model generator 206 performs an optimization technique for each articulation state to learn the geometry and appearance of the articulation state. The data used for such an optimization technique is the set of multi-view RGB-D images for each articulation state 202 and 204. The operations performed by object model generator 206 are described in greater detail below in conjunction with FIG. 3. Mesh generator 210 generates 3D object shapes 212-1 and 212-2 for each articulation state from object models 208-1 and 208-2, respectively. Mesh generator 210 can perform any technically feasible technique, such as the Marching Cubes algorithm, to generate 3D object shapes 212-1 and 212-2 from object models 208-1 and 208-2, respectively.

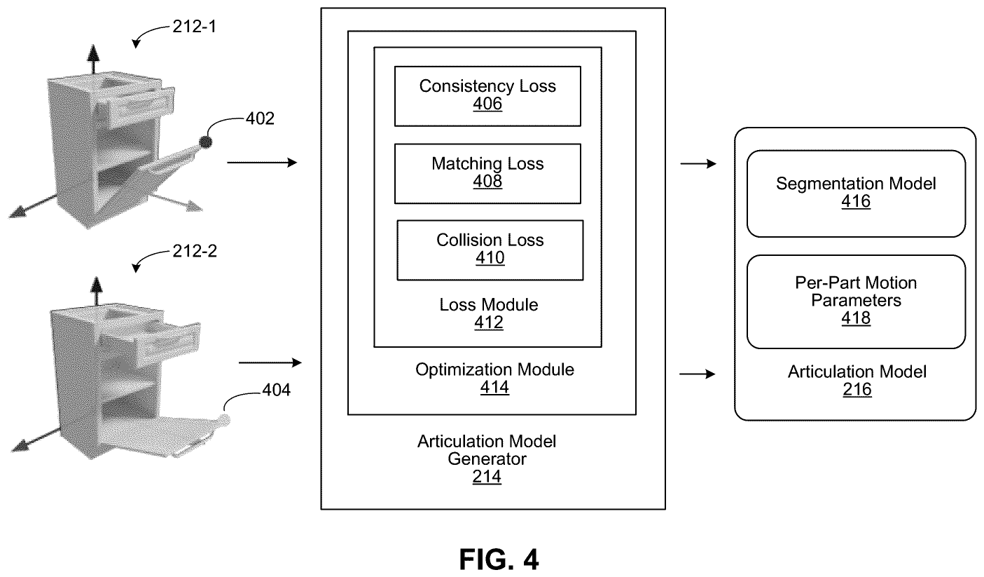

Articulation model generator 214 generates articulation model 216 that associates 3D object shapes 212-1 and 212-2 for different articulation states. In some embodiments, articulation model generator 214 derives a point correspondence field between two articulation states that is further optimized to compute articulation model 216, which includes a part segmentation and a part motion transformation between the articulation states. In such cases, the optimization process is supervised by geometry and appearance information obtained from object models 208-1 and 208-2. The part segmentation can be defined as the probability that each point in object shape 212-1 and 212-2 belongs to a specific part. The part motion transformation includes rotations and translations to map two articulated states to each other. The operations performed by articulation model generator 214 are described in greater detail below in conjunction with FIG. 4.

FIG. 3 is a more detailed illustration of object model generator 206 of FIG. 2, according to various embodiments. As shown, object model generator 206 includes an optimization module 302. In operation, object model generator 206 takes as input sets of images 202 and 204 of an articulated object (shown as a desk) with two different articulations that are captured from multiple viewpoints. Given such inputs, object model generator 206 generates an object model 208-1 and 208-2 for each of the sets of images 202 and 204, respectively. Illustratively, object model 208-1 includes a geometry model 304-1 and an appearance model 306-1, and object model 208-2 includes a geometry model 304-2 and an appearance model 306-2.

In some embodiments, object models 208-1 and 208-2 can include any technically feasible machine learning models, such as artificial neural networks, that can be trained to represent the 3D geometry and appearance of an articulated object in the sets of images 202 and 204, respectively. In such cases, optimization module 302 of object model generator 206 can perform any technically feasible training technique, such as the BundleSDF technique, to optimize parameters of the machine learning models.

More formally, given multi-view posed RGB-D images (e.g., input sets of images 202 and 204) of an object [symbol] ^{t} at state t∈{0,1}, the goal is to reconstruct object geometry, represented by an object model (e.g., object model 208-1 or 208-2) such as a Neural Object Field (Ω^{t}, Φ^{t}) (t is omitted for simplicity in the following), where a geometry network Ω: x [symbol] s (e.g., geometry model 304-1 or 304-2) maps spatial point x∈ [symbol] ³ to a truncated signed distance d∈ [symbol] , and an appearance network Φ: (x, d) [symbol] c (e.g., appearance model 306-1 or 306-2) maps point x∈ [symbol] ³ and view direction d∈ [symbol] ² to RGB color C∈ [symbol] ₊³.

In some embodiments, the geometry and appearance networks Ω and Φ, respectively, can be implemented with multiresolution hash encoding and are supervised with RGB-D images via a color rendering loss [symbol] _{c}, and a signed distance function (SDF) loss [symbol] _{SDF}. In some embodiments, the BundleSDF technique, or any other suitable technique, can be used to train the geometry and appearance networks.

After object model generator 206 generates object models 208-1 and 208-2 via optimization, mesh generator 210 can generate object mesh [symbol] ^{t} (e.g., object shape 212-1 and 212-2) by extracting the zero level set from the geometry network Ω using, e.g., the Marching Cubes algorithm, from which mesh generator 210 can further compute the Euclidean signed distance field (ESDF) Ω(x), as well as the occupancy field Occ(x), defined as Equation (1).

$$Occ ( x ) = clip ( 0.5 - \frac{\tilde{Ω} ( x )}{s} , 0 , 1 ) , \qquad ( 1 )$$

where s is set to a small number to make the function transition continuously near the object surface.

FIG. 4 is a more detailed illustration of the articulation model generator 214 of FIG. 2, according to various embodiments. As shown, articulation model generator 214 includes an optimization module 414 that includes a loss module 412, and loss module 412 uses a consistency loss 406, a matching loss 408, and a collision loss 410. In operation, articulation model generator 214 receives object shapes 212-1 and 212-2 generated by mesh generator 210 from object models 208-1 and 208-2, respectively, and articulation model generator 214 generates articulation model 216.

In some embodiments, for an articulated object with M parts, articulation model generator 214 models the articulation from state t to state t′=1−t with 1) a part segmentation field f^{t}:x [symbol] i that maps spatial point x∈ [symbol] ^{t} from the object at state t to a part label i∈{0, . . . , M−1}, and 2) a per-part rigid transformation [symbol] =(Rᵢ^{t}, tᵢ^{t})∈SE(3) that transforms part i from state t to state t′. Optimization module 414 of articulation model generator 214 generates articulation model 216 that associates object shapes 212-1 and 212-2 corresponding to two different articulation states. As shown, articulation model 216 includes a segmentation model 416 which is a probability distribution of articulation parts and per-part motion parameters 418, which include rotations and translations needed to map two different object articulations.

Optimization module 414 of articulation model generator 214 can perform any technically feasible training technique to optimize parameters of articulation model 216. In some embodiments, optimization module 414 finds a correspondence field between articulation states using geometry and appearance information obtained from object shapes 212-1 and 212-2.

For differentiable optimization, instead of hard segmentation f of points to parts, articulation model generator 214 can model part segmentation as a probability distribution over parts using P^{t}(x, i), the probability that point x in state t belongs to part i. In some embodiments, P^{t} can be implemented as a dense voxel-based 3D feature volume followed by Multi-Layer Perceptron (MLP) segmentation heads and rigid transformations that are parameterized by rotations with the 6D representations and translations with 3D vectors.

The point correspondence field maps any object point x from state t to a new position x^{t→t′} at state t′ when point x moves forward with the motion of the part point x belongs to. The point correspondence field can “render” the articulation model 216 for supervision. The point correspondence field is formulated in Equation (2),

$${x}^{t \to {t}^{r}} = \vec{Fwd} ( x , {f}^{t} , {T}^{t} ) = {\sum }_{i} {P}^{t} ( x , i ) ( {R}_{i}^{t} x + {t}_{i}^{t} ) . \qquad ( 2 )$$

Optimization module 414 uses loss module 412 to optimize the point correspondence field in Equation (2) from two articulation states (f⁰, [symbol] ⁰), (f¹, [symbol] ¹). As both articulation states describe the same articulation model 216, the part motions [symbol] can be reduced to [symbol] =(Rᵢ⁰, tᵢ⁰)⁻¹, ∀i.

In some embodiments, loss module 412 uses consistency loss 406, matching loss 408, and collision loss 410. Consistency loss 406 computes local geometry and appearance consistency of corresponding points at respective articulation states. For near-surface points x∈ [symbol] ={x||\hat{Ω}(x)|λ_{surf}}, corresponding points x^{t→t′} have consistent SDF and color. The loss terms related to near-surface points are defined as SDF consistency loss lₛ and RGB consistency loss l_{c} in Equation (3):

$${l}_{s} ( x ) = {( {\tilde{Ω}}^{t} ( x ) - {\tilde{Ω}}^{{t}^{′}} ( {x}^{t \to {t}^{′}} ) )}^{2} , \qquad ( 3 )$$

$${l}_{c} ( x ) = {‖ {Φ}^{t} ( x , d ) - {Φ}^{{t}^{′}} ( {x}^{t \to {t}^{′}} , {d}^{′} ) ‖}_{2}^{2} ,$$

where d denotes the direction that the ray x is sampled from, and d′ denotes the ray direction d transformed by x's part motion.

To extend optimization module 414 to points away from the surface with less confidence about the reconstructed SDF or color, the consistency can be computed on the occupancy values. The occupancy consistency loss lₒ is defined in Equation (4):

$${l}_{o} = {‖ {Occ}^{c} ( x ) - {Occ}^{{t}^{′}} ( {x}^{t \to {t}^{′}} ) ‖}_{2}^{2} \qquad ( 4 )$$

In some embodiments, the SDF and color consistency loss on points x sampled along camera rays r(t)=o+td are weighted based on the proximity to the object surface. In some other embodiments, the occupancy consistency loss is computed on points uniformly sampled from the unit space. In such cases, the consistency loss 406 [symbol] _{cns} is defined in Equations (5) and (6):

$${ℒ}_{cns} = {x ∈ {X}_{tarf}^{t}}_{} [ {w}^{t} ( x ) ( {λ}_{s} {l}_{s} ( x ) + {λ}_{c} {l}_{c} ( x ) ) ] + {x}_{} [ {λ}_{o} {l}_{o} ( x ) ] , \qquad ( 5 )$$

$$w ( x ) = Sigmoid ( - α \tilde{Ω} ( x ) ) \cdot Sigmoid ( α \tilde{Ω} ( x ) ) , \qquad ( 6 )$$

where w(x) is a bell-shaped function that peaks at the object surface, and hyperparameter α controls the sharpness.

Matching loss 408 uses visual cues from image observations, specifically by leveraging 2D pixel matches across images at two articulation states, obtained by, e.g., the Detector-Free Local Feature Matching with Transformers (LoFTR) algorithm. For image lᵥ^{t} taken from view v at state t, K images {lᵤ^{t′}|u∈ [symbol] } from state t′ are selected, where [symbol] is the number of viewpoints at t′ that are closest to view v. Each image pair (lᵥ^{t},lᵤ^{l′}^{ᵢ}) is fed into the LoFTR algorithm to get L pairs of pixel matches [symbol] _{e,u,t}={(pⱼ, qⱼ)}ⱼ. For pixel pair (p, q), let r be the camera ray from view v that passes through p. The 2D correspondence of p at state t′ from view u can be approximated with Equation (7):

$${p}_{v \to u}^{t \to {t}^{′}} = {π}_{u} ( \frac{{\sum }_{x ∈ r ∩ {x}_{surf}} {w}^{t} ( x ) {x}^{t \to {t}^{′}}}{{\sum }_{x ∈ r ∩ {x}_{surf}} {w}^{t} ( x )} ) , \qquad ( 7 )$$

where πᵤ projects 3D points to view u, w^{t}(x) is given by Equation (6). The matching loss 408 is then averaged over all matching pixel pairs from all image pairs in Equation (8):

$${ℒ}_{match} = {( p , q ) ∈ {M}_{v , u , t} , u ∈ {N}_{v} , v = 0 , … , V - 1 , t ∈ \{ 0 , 1 \}}_{} {‖ {p}_{v \to u}^{t \to {t}^{′}} - q ‖}_{2}^{2} , \qquad ( 8 )$$

Collision Loss 410 starts from a point y at state t′, and backtraces a set of points at state t that may forward to point y with a given articulation model 216 and be defined as [symbol] (y, f^{t}, [symbol] ^{t})={x|\vec{Fwd}(x, f^{t}, [symbol] ^{t})=y}. For hard segmentation f^{t}, x∈ [symbol] (y) follows one of M rigid part motions. Collision loss 410 obtains a candidate set [symbol] (y) by iterating over all possible parts, [symbol] (y)⊂ [symbol] (y)={(Rᵢ^{t})⁻¹(y−tᵢ^{t})}ᵢ. During optimization, collision loss 410 uses [symbol] (y) as an approximation despite having a soft segmentation P.

Candidate point xᵢ=(Rᵢ^{t})⁻¹(y−tᵢ^{t}) corresponds to y only if xᵢ is on part i, which can be verified by checking occupancy Occ(x) and part segmentation P(x, i). The probability of point xᵢ corresponding to y is defined in Equation (9):

$${a}_{i} = {P}^{t} ( {x}_{i} , i ) \cdot {Occ}^{t} ( {x}_{i} ) , \qquad ( 9 )$$

where Occ(x) is defined by Equation (1).

Collision loss 410 counts the number of points that correspond to y by summing contributions from all xᵢ and reporting a collision when the result is larger than 1. Collision loss 410 is defined in Equation (10):

$${ℒ}_{coll} = {y}_{} [ {ReLU ( \vert ( y ) \vert - 1 )}^{2} ] , \qquad ( 10 )$$

$$\vert ( y ) \vert = {\sum }_{i} {a}_{i}$$

where y is uniformly sampled in the unit space. The total loss that optimization module 414 uses is defined in Equation (11):

$$ℒ = {λ}_{cns} {ℒ}_{cns} + {λ}_{match} {ℒ}_{match} + {λ}_{coll} {ℒ}_{coll .} \qquad ( 11 )$$

In cases where only part of the object is visible due to limited viewpoints and/or self-occlusions, or in cases where some points are only visible in one state (e.g., points in the interior of the drawer), optimization module 414 may not find the corresponding points. In such cases, optimization module 414 can compute the visibility of point x by projecting to all camera views and checking if point x is in front of the depth (at the projected pixel) beyond a certain threshold ϵ, as defined in Equation (12):

$$vis ( x ) = {V}_{v = 0}^{V - 1} [ {d}_{v} ( {π}_{v} ( x ) ) + ϵ > {dist}_{v} ( x ) ] , \qquad ( 12 )$$

where V denotes logical OR, dᵥ denotes observed depth at view v; πᵥ(x) denotes 2D projection; and distᵥ(x) denotes the distance along the optical axis from x to the camera origin. Let [symbol] ^{t}={x|¬vis(x)} denote the set of unobserved points at state t. During mesh generation, mesh generator 210 forces the space to be empty at these points, such that surface reconstructions only contain observed regions. Optimization module 414 also discounts the point consistency loss at x by a factor of wᵥᵢₛ if x^{t→t}^{^{r}}∈ [symbol] ^{t′}, (e.g., point correspondence in the other state is not observed). wᵥᵢₛ can be set to a small nonzero number to avoid learning collapse, which makes all points correspond to unobserved points to reduce consistency loss.

Given the reconstructed shape and articulation models ( [symbol] ^{t}, P^{t}, [symbol] ^{t}), t∈{0,1}, in some embodiments, the 3D representation application 116 can also extract an explicit articulated object model (not shown). In such cases, to predict joint i of the explicit articulated object model, the 3D representation application 116 can take the shared part motion [symbol] =(Rᵢ⁰, tᵢ⁰) and classify joint i as prismatic if | angle (Rᵢ⁰)|<τᵣ, and revolute otherwise. The 3D representation application 116 can then project [symbol] to the manifold of pure-rotational or translational transformations and compute joint axes and relative joint states. For part-level geometry, the 3D representation application 116 can first identify the state t*∈{0,1} with better part visibility, e.g., when a drawer is open instead of closed. The 3D representation application 116 can then compute hard segmentation f^{t*}(x)=arg maxᵢP^{t*}(x, i), and extract each part mesh by checking their vertex part index as [symbol] ={v|v∈ [symbol] ^{t*}, f^{t*}(v)=i}.

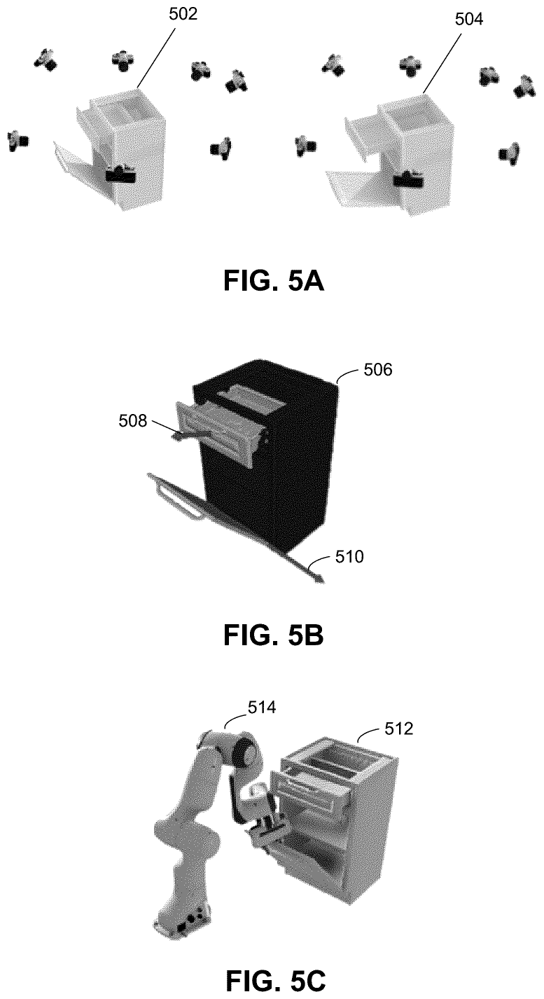

FIGS. 5A-5C illustrate exemplar inputs and outputs of 3D representation application 116, according to various embodiments. As shown in FIG. 5A, sets of RGB-D images corresponding to two different articulation states 502 and 504 of a desk can be taken. Each of the sets of RGB-D images 502 and 504 includes images that are captured from multiple different viewpoints. In some embodiments, 3D representation application 116 receives sets of RGB-D images corresponding to an initial articulation state and a final articulation state of an articulated object.

3D representation application 116 processes the received images and generates an articulation model 506, shown in FIG. 5B. As shown, articulation model 506 includes a part segmentation and a part motion transformation between the articulation states 502 and 504. Illustratively, the articulation model 506 is segmented into three part segmentations of a segmented desk corresponding to a drawer, a body, and a door of the desk. Arrows 508 and 510 show the direction of movement or axis of rotation for articulated parts of the desk. For example, arrow 508 is attached to the drawer and points to the direction of movement of the drawer, which can only move in and out of the desk. Arrow 510 is attached to the door and shows the axis of rotation of the door, which can open and close with that axis.

FIG. 5C shows a robot 514 interacting with desk 512. As shown, robot 514 uses articulation model 506, including the part segmentation and part motion transformations of articulation model 506, to interact with the desk 512.

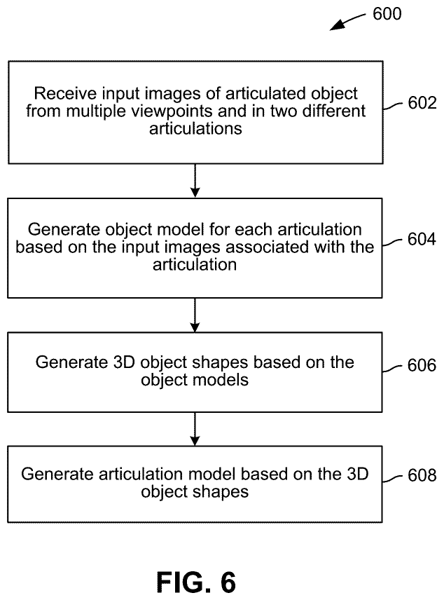

FIG. 6 is a flow diagram of method steps for generating a three-dimensional representation of an articulated object, according to various embodiments. Although the method steps are described in conjunction with the systems of FIGS. 1-4, persons skilled in the art will understand that any system configured to perform the method steps in any order falls within the scope of the present embodiments.

As shown, a method 600 begins at step 602, where 3D representation application 116 receives input images (e.g., images 202 and 204) of an articulated object from multiple viewpoints and in two different articulations. In some embodiments, 3D representation application 116 receives sets of RGB-D images corresponding to an initial articulation state and a final articulation state of an articulated object.

At step 604, 3D representation application 116 generates an object model (e.g., object models 208-1 and 208-2) for each articulation based on the input images associated with the articulation. 3D representation application 116 generates object models (e.g., object models 208-1 and 208-2) that represent the geometry and appearance of a 3D articulated object within the corresponding sets of input images 202 and 204. In some embodiments, 3D representation application 116 performs an optimization technique for each articulation state to learn the geometry and appearance of the articulation state, as described above in conjunction with FIGS. 2-3.

At step 606, 3D representation application 116 generates 3D object shapes (e.g., 3D object shapes 212-1 and 212-2) based on the object models. For example, 3D representation application 116 generates 3D object shapes 212-1 and 212-2 for each articulation state from object models 208-1 and 208-2, respectively. 3D representation application 116 can perform any technically feasible technique, such as the Marching Cubes algorithm, to generate 3D object shapes 212-1 and 212-2.

At step 608, 3D representation application 116 generates an articulation model (e.g., articulation model 216) based on the 3D object shapes (e.g., 3D object shapes 212-1 and 212-2). 3D representation application 116 generates articulation model 216 that associates 3D object shapes 212-1 and 212-2 for different articulation states. In some embodiments, 3D representation application 116 derives a point correspondence field between two articulation states that is further optimized to compute an articulation model (e.g., articulation model 216) that includes a part segmentation and a part motion transformation between the articulation states, as described above in conjunction with FIG. 4.

In sum, techniques are disclosed for generating digital 3D representations of articulated objects. In some embodiments, a 3D representation application receives as input images of an articulated object from multiple viewpoints and in two different articulations. The 3D representation application generates an object model for each articulation via a first optimization technique using the input images associated with the articulation. Then, the 3D representation application generates 3D geometry from each object model using a reconstruction technique. Thereafter, the 3D representation application generates an articulation model via a second optimization technique using the 3D geometry generated from each object model. The articulation model includes a segmentation model that segments parts of the articulated object and a set of motion parameters defining motions of each of the segmented parts. In some embodiments, the second optimization technique includes performing backpropagation to update the motion parameters along with parameters of the segmentation model and minimizing a loss function that includes a consistency loss term that penalizes geometric and appearance inconsistencies between corresponding points in different articulations, a matching loss term that penalizes unmatching image features between pixel pairs in different articulations, and a collision loss term that penalizes collisions between parts after applying a predicted forward motion.

At least one technical advantage of the disclosed techniques relative to the prior art is that 3D reconstructions of articulated objects generated using the disclosed techniques can be more accurate and stable than 3D reconstructions of articulated objects generated using conventional approaches. In addition, the disclosed techniques can handle articulated objects having more than one movable part as well as arbitrary novel objects, because the disclosed techniques do not rely on an object shape or structure prior. These technical advantages represent one or more technological improvements over prior art approaches.

1. In some embodiments, a computer-implemented method for generating an articulation model comprises receiving a first set of images of an object in a first articulation and a second set of images of the object in a second articulation, performing one or more operations to generate first three-dimensional (3D) geometry based on the first set of images, performing one or more operations to generate second 3D geometry based on the second set of images, and performing one or more operations to generate an articulation model of the object based on the first 3D geometry and the second 3D geometry.

2. The computer-implemented method of clause 1, wherein performing one or more operations to generate the first 3D geometry comprises performing one or more operations to generate a first model of the object in the first articulation based on the first set of images, and performing one or more operations to generate the first 3D geometry based on the first model.

3. The computer-implemented method of clauses 1 or 2, wherein performing one or more operations to generate first model comprises performing one or more iterative operations to update parameters of at least one machine learning model included in the first model based on the first set of images.

4. The computer-implemented method of any of clauses 1-3, wherein the first model comprises a first machine learning model associated with geometry of the object and a second machine learning model associated with an appearance of the object.

5. The computer-implemented method of any of clauses 1-4, wherein performing one or more operations to generate the first 3D geometry based on the first model comprises performing one or more operations of a reconstruction technique.

6. The computer-implemented method of any of clauses 1-5, wherein the articulation model comprises a segmentation model that segments a plurality of parts of the object and a set of motion parameters defining one or more motions of each part included in the plurality of parts.

7. The computer-implemented method of any of clauses 1-6, wherein performing one or more operations to generate the articulation model comprises performing one or more backpropagation operations to update the set of motion parameters and one or more parameters of the segmentation model.

8. The computer-implemented method of any of clauses 1-7, wherein the one or more backpropagation operations minimize a loss function that comprises at least one of a consistency loss term that penalizes inconsistencies between corresponding points in the first articulation and the second articulation, a matching loss term that penalizes unmatching image features between pixel pairs the first articulation and the second articulation, and a collision loss term that penalizes collisions between one or more parts included in the plurality of parts after applying a predicted forward motion from the first articulation to the second articulation.

9. The computer-implemented method of any of clauses 1-8, further comprising performing one or more operations to simulate the articulation model in an extended reality (XR) environment.

10. The computer-implemented method of any of clauses 1-9, further comprising performing one or more operations to control a robot based on the articulation model.

11. In some embodiments, one or more non-transitory computer-readable storage media include instructions that, when executed by at least one processor, cause the at least one processor to perform steps for generating an articulation model, the steps comprising receiving a first set of images of an object in a first articulation and a second set of images of the object in a second articulation, performing one or more operations to generate first three-dimensional (3D) geometry based on the first set of images, performing one or more operations to generate second 3D geometry based on the second set of images, and performing one or more operations to generate an articulation model of the object based on the first 3D geometry and the second 3D geometry.

12. The one or more non-transitory computer-readable storage media of clause 11, wherein performing one or more operations to generate the first 3D geometry comprises performing one or more operations to generate a first model of the object in the first articulation based on the first set of images, and performing one or more operations to generate the first 3D geometry based on the first model.

13. The one or more non-transitory computer-readable storage media of clauses 11 or 12, wherein performing one or more operations to generate the first model comprises performing one or more iterative operations to update parameters of at least one machine learning model included in the first model based on the first set of images.

14. The one or more non-transitory computer-readable storage media of any of clauses 11-13, wherein the first model comprises a first machine learning model associated with geometry of the object and a second machine learning model associated with an appearance of the object.

15. The one or more non-transitory computer-readable storage media of any of clauses 11-14, wherein the articulation model comprises a segmentation model that segments a plurality of parts of the object and a set of motion parameters defining one or more motions of each part included in the plurality of parts.

16. The one or more non-transitory computer-readable storage media of any of clauses 11-15, wherein performing one or more operations to generate the articulation model comprises performing one or more backpropagation operations to update the set of motion parameters and one or more parameters of the segmentation model.

17. The one or more non-transitory computer-readable storage media of any of clauses 11-16, wherein the segmentation model comprises a probability distribution associated with the plurality of parts.

18. The one or more non-transitory computer-readable storage media of any of clauses 11-17, wherein the first set of images includes a plurality of RGB-D (red, green, blue, depth) images of the object in the first articulation captured from different viewpoints.

19. The one or more non-transitory computer-readable storage media of any of clauses 11-18, wherein the instructions, when executed by the at least one processor, further cause the at least one processor to perform the step of performing one or more operations to at least one of simulate the articulation model in an extended reality (XR) environment or control a robot based on the articulation model.

20. In some embodiments, a system comprises one or more memories storing instructions, and one or more processors that are coupled to the one or more memories and, when executing the instructions, are configured to receive a first set of images of an object in a first articulation and a second set of images of the object in a second articulation, perform one or more operations to generate first three-dimensional (3D) geometry based on the first set of images, perform one or more operations to generate second 3D geometry based on the second set of images, and perform one or more operations to generate an articulation model of the object based on the first 3D geometry and the second 3D geometry.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating an articulation model, the method comprising:
receiving a first set of images of an object in a first articulation and a second set of images of the object in a second articulation;
performing one or more operations to generate first three-dimensional (3D) geometry based on the first set of images;
performing one or more operations to generate second 3D geometry based on the second set of images; and
performing one or more operations to generate an articulation model of the object based on the first 3D geometry and the second 3D geometry.

2. The computer-implemented method of claim 1, wherein performing one or more operations to generate the first 3D geometry comprises:
performing one or more operations to generate a first model of the object in the first articulation based on the first set of images; and
performing one or more operations to generate the first 3D geometry based on the first model.

3. The computer-implemented method of claim 2, wherein performing one or more operations to generate first model comprises performing one or more iterative operations to update parameters of at least one machine learning model included in the first model based on the first set of images.

4. The computer-implemented method of claim 2, wherein the first model comprises a first machine learning model associated with geometry of the object and a second machine learning model associated with an appearance of the object.

5. The computer-implemented method of claim 2, wherein performing one or more operations to generate the first 3D geometry based on the first model comprises performing one or more operations of a reconstruction technique.

6. The computer-implemented method of claim 1, wherein the articulation model comprises a segmentation model that segments a plurality of parts of the object and a set of motion parameters defining one or more motions of each part included in the plurality of parts.

7. The computer-implemented method of claim 6, wherein performing one or more operations to generate the articulation model comprises performing one or more backpropagation operations to update the set of motion parameters and one or more parameters of the segmentation model.

8. The computer-implemented method of claim 7, wherein the one or more backpropagation operations minimize a loss function that comprises at least one of a consistency loss term that penalizes inconsistencies between corresponding points in the first articulation and the second articulation, a matching loss term that penalizes unmatching image features between pixel pairs the first articulation and the second articulation, and a collision loss term that penalizes collisions between one or more parts included in the plurality of parts after applying a predicted forward motion from the first articulation to the second articulation.

9. The computer-implemented method of claim 1, further comprising performing one or more operations to simulate the articulation model in an extended reality (XR) environment.

10. The computer-implemented method of claim 1, further comprising performing one or more operations to control a robot based on the articulation model.

11. One or more non-transitory computer-readable storage media including instructions that, when executed by at least one processor, cause the at least one processor to perform steps for generating an articulation model, the steps comprising:
receiving a first set of images of an object in a first articulation and a second set of images of the object in a second articulation;
performing one or more operations to generate first three-dimensional (3D) geometry based on the first set of images;
performing one or more operations to generate second 3D geometry based on the second set of images; and
performing one or more operations to generate an articulation model of the object based on the first 3D geometry and the second 3D geometry.

12. The one or more non-transitory computer-readable storage media of claim 11, wherein performing one or more operations to generate the first 3D geometry comprises:
performing one or more operations to generate a first model of the object in the first articulation based on the first set of images; and
performing one or more operations to generate the first 3D geometry based on the first model.

13. The one or more non-transitory computer-readable storage media of claim 12, wherein performing one or more operations to generate the first model comprises performing one or more iterative operations to update parameters of at least one machine learning model included in the first model based on the first set of images.

14. The one or more non-transitory computer-readable storage media of claim 12, wherein the first model comprises a first machine learning model associated with geometry of the object and a second machine learning model associated with an appearance of the object.

15. The one or more non-transitory computer-readable storage media of claim 11, wherein the articulation model comprises a segmentation model that segments a plurality of parts of the object and a set of motion parameters defining one or more motions of each part included in the plurality of parts.

16. The one or more non-transitory computer-readable storage media of claim 11, wherein performing one or more operations to generate the articulation model comprises performing one or more backpropagation operations to update the set of motion parameters and one or more parameters of the segmentation model.

17. The one or more non-transitory computer-readable storage media of claim 16, wherein the segmentation model comprises a probability distribution associated with the plurality of parts.

18. The one or more non-transitory computer-readable storage media of claim 11, wherein the first set of images includes a plurality of RGB-D (red, green, blue, depth) images of the object in the first articulation captured from different viewpoints.

19. The one or more non-transitory computer-readable storage media of claim 11, wherein the instructions, when executed by the at least one processor, further cause the at least one processor to perform the step of performing one or more operations to at least one of simulate the articulation model in an extended reality (XR) environment or control a robot based on the articulation model.

20. A system, comprising:
one or more memories storing instructions; and
one or more processors that are coupled to the one or more memories and, when executing the instructions, are configured to:
receive a first set of images of an object in a first articulation and a second set of images of the object in a second articulation,
perform one or more operations to generate first three-dimensional (3D) geometry based on the first set of images,
perform one or more operations to generate second 3D geometry based on the second set of images, and
perform one or more operations to generate an articulation model of the object based on the first 3D geometry and the second 3D geometry.
